(19) United States
(12) Patent Application Publication
(10) Pub. No.: US 2005/0159830 A1
(43) Pub. Date: Jul. 21, 2005

(54) Audio player with relay capability

(76) Inventor: Ming-Hsiang Yeh, Taipei City (TW)

Correspondence Address: TROXELL LAW OFFICE PLLC, 5205 LEESBURG PIKE, SUITE 1404, FALLS CHURCH, VA, 22041, US

(21) Appl. No.: 10/760,312

(22) Filed: Jan. 21, 2004

(51) Int. Cl. G06F 17/00

(52) U.S. Cl. 700/94

(57) ABSTRACT

An audio player includes a processor, a FM transmitter electrically connected to the processor to transmit low power frequency, a USB interface electrically connected to the processor for connection with other appliance, a controller electrically connected to the processor and having at least one key to correspond to and control options in the processor, a display electrically connected to the processor to display the selected option in the processor by the controller, a storage electrically connected to the processor to store information therein, a decoder electrically connected to the processor to decode digital audio information so that the digital audio information is converted to digital information and an analog/digital converter electrically connected to the decoder to convert the decoded digital information to audio signal to enable other appliance to properly play the audio signal directly.

### BACKGROUND OF THE INVENTION

1. Field of the Invention

The present invention relates to an audio player, and more particularly to an audio player to process audio information in the audio player so as that the audio information may be played in an appliance with FM (Frequency Modulation) built in.

2. Description of Related Art

Currently, the existing MP3 player is able to store large amount of audio information via the processor and the storage device. Due to the advanced compressing technique, the conventional diskette and tapes are gradually obsolete. Although the MP3 player is able to process large amount of information, the MP3 user can only listen to the music directly from the headset or indirectly from the speaker connected to the output of the MP3 player. Alternatively, the MP3 player may use the USB (universal series bus) to link with other appliances so as to accomplish the transmission of digital information. As a result, the application of the MP3 player is limited in many aspects.

To overcome the shortcomings, the present invention tends to provide an improved audio player to mitigate the aforementioned problems.

### SUMMARY OF THE INVENTION

The primary objective of the present invention is to provide an improved audio player having a FM transmitter to transmit low power frequency so that the audio information in the audio player may be played elsewhere having a FM built therein.

Other objects, advantages and novel features of the invention will become more apparent from the following detailed description when taken in conjunction with the accompanying drawings.

### BRIEF DESCRIPTION OF THE DRAWINGS

FIG. 1 is a block diagram of the audio player of the present invention;

FIG. 2 is a perspective view of the audio player of the present invention; and

FIG. 3 is a schematic view showing the application of the audio player of the present invention.

### DETAILED DESCRIPTION OF THE PREFERRED EMBODIMENT

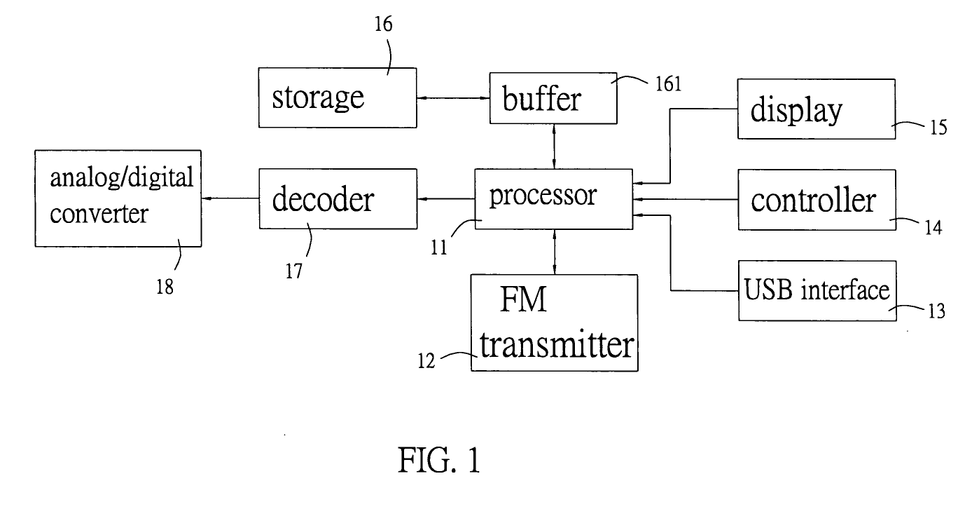

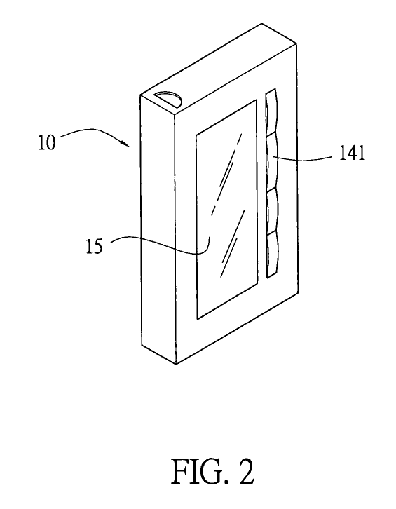

With reference to FIGS. 1 and 2, the audio player (10) in accordance with the present invention includes a processor (11), a FM transmitter (12), a USB (universal series bus) interface (13), a controller (14), a display (15), a storage (16), a decoder (17) and an analog/digital converter (18) such that the audio player (10) is able to use the FM transmitter (12) to link with other appliances with FM function to enable other appliance to play the audio information.

The processor (11) is the operation center of the audio player. The FM transmitter (12) is electrically connected to the processor (11) to transmit low power frequency and may be designed to have at least one low power frequency, i.e. 4, 8, 16 etc. The USB interface (13) is electrically connected to the processor (11) to link the audio player (10) of the present invention with other appliance. The controller (14) is electrically connected to the processor (11) and has at least one key (141) to correspond to and control options in the processor (11). The display (15) is electrically connected to the processor (11) to display the selected in the processor (11) by the controller (14). The display (15) is adjacent to the key (141) of the controller (14). The storage (16) is electrically connected to the processor (11) to store information therein. The information may be MP3 information or MPEG4 information. It is noted that a buffer (161) is sandwiched by the storage (16) and the processor (11). The decoder (17) is electrically connected to the processor (11) to decode the digital audio information so that the digital audio information is converted to digital information, wherein the decoder (17) is a MP3 decoder. The analog/digital converter (18) is electrically connected to the decoder (17) and converts the decoded digital information to audio signal to enable other appliance to properly play the audio signal directly.

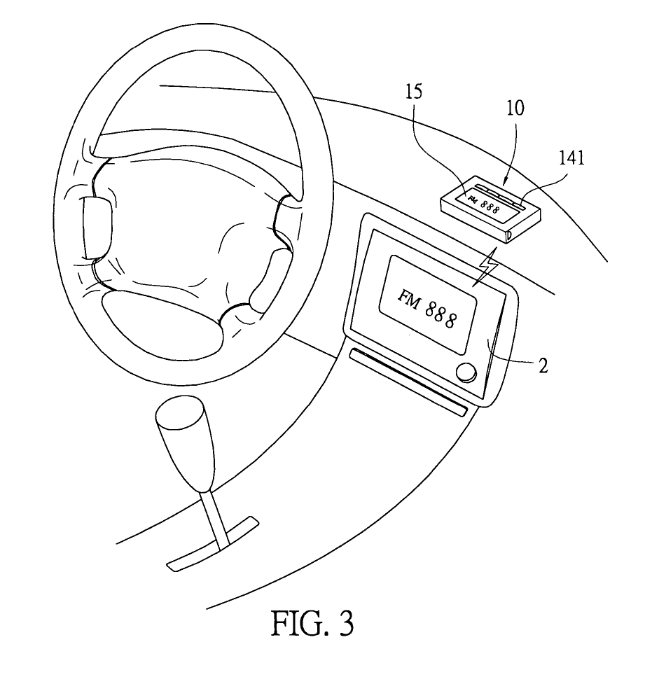

With reference to FIG. 3, when the audio player (10) of the present invention is in application, the key (141) from the controller (14) is pressed to select a frequency in the FM transmitter (12) to be transmitted. The selected frequency is then displayed on the display (15). After the operator confirms the selected frequency information, an appliance (2) with built-in FM function is placed to correspond to the frequency of the FM transmitter (12) such that the processor (11) is able to catch the audio signal in the storage (16). The audio signal is then processed by the decoder (17) to become digital signal. Thereafter, the analog/digital converter (18) converts the digital signal to an audio signal and outputs the audio signal. Whereby the appliance (2) has a frequency the same as the selected frequency of the FM transmitter (12) so that the appliance (2) is able to play the music stored in the storage (16).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An audio player comprising:
a processor;
a FM transmitter electrically connected to the processor to transmit low power frequency;
a USB interface electrically connected to the processor for connection with an appliance;
a controller electrically connected to the processor and having at least one key to correspond to and control options in the processor;
a display electrically connected to the processor to display the selected option in the processor by the controller;
a storage electrically connected to the processor to store information and for providing information to the appliance;
a decoder electrically connected to the processor to decode digital audio information so that the digital audio information is converted to digital information, wherein the decoder is a MP3 decoder; and
an analog/digital converter electrically connected to the decoder to convert the decoded digital information to audio signal to enable the appliance to properly play the audio signal directly.

2. The audio player as claimed in claim 1, wherein the FM transmitter has at least one low power frequency.

3. The audio player as claimed in claim 1, wherein a buffer is sandwiched between the storage and the processor.
